(19) United States
(12) Patent Application Publication
(10) Pub. No.: US 2015/0216100 A1
(43) Pub. Date: Aug. 6, 2015

(54) Cutting Device

(71) Applicant: Marcel Baur, Tamarama (AU)

(72) Inventor: Marcel Baur, Tamarama (AU)

(21) Appl. No.: 14/616,327

(22) Filed: Feb. 6, 2015

Related U.S. Application Data
(60) Provisional application No. 61/936,672, filed on Feb. 6, 2014.

(51) Int. Cl. A01B 35/20; A01G 23/06; A01B 35/00

(52) U.S. Cl. CPC A01B 35/20; A01B 35/00; A01G 23/06

(57) ABSTRACT

A cutting device that can be used, among other things, for efficiently removing items such as extant trees and vegetation by cutting the subterranean root systems in situ with a powered multi-blade system. Among other uses, the cutting device may be implemented and deployed as a powered multi-blade device with cyclic, reciprocating or ellipsoid cutting action that severs root and other comparable matter such as cable in situ, without having to drag same to the surface.

### CROSS REFERENCE TO RELATED APPLICATIONS

This disclosure claims the benefit of the priority of U.S. Provisional Application Ser. No. 61/936,672, filed Feb. 6, 2014, and entitled “Cutting Device”, which is incorporated herein by reference in its entirety.

This application relates to a cutting device, for example, a mechanical device for efficiently removing extant trees, vegetation, and/or sub-surface entanglements.

### BACKGROUND

Clearing vegetation for cultivation or cropping or reclamation is a task undertaken around the world. Land clearance is undertaken on virgin forest or may be undertaken as part of land re-generation and re-purposing and reclamation, which requires removal of extant vegetation. Vegetation may include small trees and undergrowth and/or large trees. All trees and vegetation have root systems/root balls/stumps of one kind or another and these root systems are an impediment to the preparation of the ground in readiness for cultivation, cropping, and the like.

Land clearance is generally a labour and equipment intensive process. Regardless of whether the extant vegetation is small/light or large established trees, the root systems/root balls/stumps must be removed for the ground to be suitable for cultivation.

In some instances, land has been used for fill and there are cables and similar materials buried but close enough to the surface to entangle plough blades and other implements used to clear and prepare ground for agricultural use or which otherwise is to be cleared of sub-surface entanglements.

Clearance of trees from land requires removal of both the above ground elements (trunk and foliage) and the root systems/root balls/stumps.

Root systems typically spread laterally around a tree rather than vertically. Lateral roots radiate from the trunk and form a network of woody tendrils. If the resultant stumps/root balls were left in the ground, they are likely to hinder use of agricultural implements and other pre-cultivation activities such as ploughing and grading.

Generally, land clearance requires deployment of heavy earth moving equipment such as tractors. This equipment uses brute force to push over vegetation such as trees, or to pull a static device such as a hook through the ground in order to pull up root systems/root balls/stumps. The hook is used to snag the root systems and drag part of the root system to the surface, where various methods are used to sever the roots in order to permit the tree to be toppled or the vegetation to be pulled out of the ground and removed.

The use of brute force necessarily requires large and powerful tractors or comparable devices to drag the hook through the ground, due to the resistance of the soil and the root systems.

### SUMMARY

The present inventor recognized that conventional land clearance techniques tend to require the use of large, cumbersome vehicles, which usually have to be brought into the site where they are not suitable for public roads. This transport to and from site adds cost, time delays and could be avoided if a smaller, more agile traction unit of the kind commonly found on farms, could be used.

Moreover, acquisition and transport of costs are directly proportional to the size of the earthmoving device in question: therefore the larger the device, the greater the cost. Consequently, where a smaller and/or less powerful device (such as the cutting device described herein) can achieve essentially the same outcome, then there are efficiency gains, cost savings and/or a reduction in ancillary consumption such as fuel and generation of carbon and exhaust gases.

The cutting device described herein is a mechanical device that can be used, among other things, for efficiently removing items such as extant trees and vegetation by cutting the subterranean root systems in situ with a powered multi-blade system. Among other uses, the cutting device may be implemented and deployed as a powered multi-blade device with cyclic, reciprocating or ellipsoid cutting action that severs root and other comparable matter such as cable in situ, without having to drag same to the surface. Moreover, the cutting device can be used above or below ground.

Implementations of the cutting device, and a method of using same, may include various combinations of the following features.

A cutting device may include a support frame (1), a skid (11) connected to the support frame (1) and configured to contact ground when the cutting device is in use, at least one moveable cutting blade (12) extending below the skid (11, and orbit-causing means (6, 8, and 13) for causing the moveable cutting blade (12) to orbit in an ellipsoidal pattern.

The cutting device may have two moveable cutting blades (12) configured to orbit either 180 degrees out of phase with each other in a controlled manner, or independently.

The cutting device may be configured such that each moveable cutting blade (12) is separately configured to compensate for variations in elliptical-oscillation movement.

The cutting device may further include a plurality of moveable cutting blades (12), wherein a quantity of cutting blades is proportional to a depth at which the cutting device is to operate.

The cutting device may be configured such that the at least one moveable cutting blade (12) comprises a curved member with teeth.

The cutting device may further include a vertical member (e.g., cutter bar arm 6) operatively coupled via a drive (13) to the support frame (1) such that the vertical member (6) can be oscillated vertically, and wherein the orbit-causing means (6, 8, and 13) converts vertical oscillation of the vertical member (6) to ellipsoidal motion.

A method of cutting sub-surface entities may involve extending a first cutting blade into a sub-surface location adjacent to, and in contact with, an object to be cut, and converting vertical oscillation input into elliptical motion to cause the first cutting blade to move in an elliptical pattern relative to a second cutting blade.

The cutting method may further include using a common drive to control a phase difference between the first and second cutting blades to maintain the phase difference at a predetermined degree.

The cutting method may further include using, for each of the first and second cutting blades, a dedicated drive to control the elliptical pattern of the respective cutting blades such that the first and second cutting blades move independently of each other.

Among other potential advantages, the disclosed cutting device, when removing trees, may prevent leaving the stump/root ball behind, which typically happened with conventional methods. Consequently, by using the disclosed cutting device, the residual stumps/root balls no longer need to be removed with large/powerful earthmoving equipment and/or manual labour intensive methods. Because the stumps/root balls are not left in the ground, cropping becomes less difficult, and the crop yield per unit area is increased. As a result, no longer is there a need to clear additional acreage to compensate for the area lost to stumps/root balls.

Further, the disclosed cutting device may decrease, or eliminate, the damage to tree trunks often caused by conventional clearance techniques and equipment. As a result, the value of the tree trunks to saw mills is increased, while decreasing the occurrence of what would otherwise be potentially valuable saw-logs being discarded as waste. Moreover, because less waste vegetation (which usually is burnt) is generated, what otherwise would result in significant quantities of smoke and carbon emissions are reduced.

Much of the native timber destroyed by conventional clearing methods could otherwise be milled using on-site equipment such as the cutting device described herein.

The cutting device may be mounted on purpose-built vehicles or may be rear-mounted on common tractors featuring three-point linkage and power take-off (“PTO”) or may be front-mounted on smaller front-end loaders/bobcats/backhoes. This is especially of value in Third World markets where relatively small tractors are more likely to be used rather than the large bulldozers and other heavy earthmoving equipment commonly used for conventional agriculture and tree removal in Western countries.

The cutting heads (also referred to herein as “blade/s”) may be located on the centreline of the bulldozer/power supply or it may be mounted off-centre so as to bring the cutting heads in line with or outside the wheel track. Offsetting the blade/s facilitates access to root systems not otherwise accessible to mechanical removal due to the track width or space limitations between the trees to be removed.

The cutting device described here may provide advantages over conventional root-cutting circular saws, which tend to be of limited effectiveness unless scaled up and fitted to large heavy-duty earth moving equipment of the kind usually found on construction sites.

Similarly, the cutting device described here may provide advantages over smaller circular saw units, which are suitable for common farming tractor mounting, but typically are limited with respect to the root cutting depths they can achieve, and which tend not to be configurable to facilitate inclined cutting under the stump/rootball.

Further, the cutting device described here may provide advantages over stump grinders (analogous to circular saws), which are used to take the stump/root ball below ground level but which tend not to extend far enough below the surface to be useful for agriculture or tree planting/replanting.

The cutting device also may obviate the need for explosives in removing of legacy stumps/rootballs.

In an implementation, the cutting device involves deployment of a blade-based cutting assembly below the ground level, at a depth appropriate to the root systems in question, so that the roots are severed in situ.

The cutting device may achieve cutting action by mounting one or more blades on a reciprocating arm which is mounted upon a mobile power source such as a tractor or other earth moving equipment by means of a support frame.

The cutting device is readily scalable. Smaller units may be attached to tractors and backhoes of the scale commonly found in farms. Large-scale versions may be mounted on heavy earthmoving equipment such as bulldozers and tracked backhoes of the kind more commonly found in large scale earthworks.

In an implementation, the cutting device uses a system of gears and levers to transfer hydraulic or mechanical motive force via the mounting arm so as to impart a cyclic and/or ellipsoidal cutting action to the blades, which are mounted at the end of the arm.

This action may take place as the device is being dragged through the ground thereby compounding the cutting action to sever root systems and cutting its way through the ground.

The device's cutting head may be deployed below the surface of the ground to a depth the operator judges sufficient to sever enough of the roots or root ball or other entangling material, to permit their removal and thereby facilitate ploughing or other activities that would otherwise be impeded by the presence of sub-surface roots or other entanglements.

In operation, the cutting heads may be deployed to cut through the roots in situ. Where a root system is severed on one side of the tree, the tree's support is greatly reduced and the tree may be pushed over readily; this process will generally bring the main part of the root system to the surface, which simplifies removal of the tree and the root-ball.

Once the roots have been severed, those parts of the root system remaining in the ground may be left or may be removed, depending on the circumstances and/or desired outcome.

### DRAWING DESCRIPTIONS

FIGS. 1A-1E are, respectively, end, side, operator's end, top, and bottom views of a cutting device having an asynchronous cutting arm in which two blades orbit 180 degrees out of sync or independently.

FIGS. 2A-2D are, respectively, side, top, bottom, and end views of a cutting device having a single cutting arm with twin blades.

FIG. 3 shows the changes in the ellipsoid motion imparted upon the blade/s by changing the relative separation distance of the mechanisms imparting vertical and horizontal movement to the cutter bar/blade/s.

FIGS. 4 and 5 illustrate operation aspects of the cutting device.

### DETAILED DESCRIPTION

A single or multiple metal or ceramic blades are mounted on an arm which is moved vertically or tangential to the ground through hydraulic, electric or mechanical power.

In an implementation, multiple blades are mounted one above the other on a cutter bar arm. Each blade is separately configured to compensate for variations in elliptical-oscillation movement. The number of blades can be increased proportional to the depth at which the cutter bar arm is to operate.

In an implementation, a counter-travelling, double blade is installed on the cutter bar arm. Alternatively, a single blade may be installed on the cutter bar arm.

The cutting blades at the end of the cutter bar arm move in an ellipsoidal path, presenting a cutting motion with limited root contact time in any one cycle of the blade assembly. This results in a controlled dynamic cutting motion, rather than a simple sawing action. The use of the ellipsoid cutting action reduces blockages of the blade and the blade's teeth and also prolongs blade life. The blade shape is designed to complement the ellipsoid motion, so as to enhance the cutting motion.

In an implementation, one cutter bar arm is attached to a support frame. Alternatively, there may be a multiplicity of cutter bar arms, each connected to the support frame.

In an implementation, a fixed shoe-like arrangement is fitted to the support frame. This shoe-like fitting would remain in contact with the ground during root cutting operations by sliding over the ground as the cutter bar arm travels through the ground with the oscillating blades cutting below the surface. This shoe-like arrangement uses contact with the ground to absorb and/or prevent bucking and heaving forces otherwise likely to be transferred through the cutter bar arm back up to the support frame and the unit upon which the present cutting device is attached.

In an implementation, the cutter bar arm is powered so as to achieve a vertical oscillation. This may be achieved by use of, for example, the output of a fence post auger gearbox. This gearbox would be mounted 90 degrees to the vertical. It would provide the cutter bar arm's vertical movement via a linkage to which the same vertical mount or mast that the auger gearbox (driving the cutting arm) was mounted. This mast may then be raised or lowered to enable the cutter bar arm to be forced or lowered into the ground as the cutter bar arm oscillates vertically to engage/cut tree roots or other entanglements.

In an implementation, a second cutter bar arm, may be installed. This arm is parallel to the other, and its blade assembly oscillates out-of-phase (also referred to as “out of sync”) or independently with the other. By this configuration, one blade may be cutting during the forward/lifting portion of the ellipsoid cycle, while the other is in the retrograde reversing/lowering portion of the cycle.

As used herein, “out of phase” (or equivalently, “out of sync”) means a predetermined or fixed degree of asynchronicity between two or more cutter bar arms, e.g., 180 degrees, or some other controlled value as the application requirements dictate. In such an arrangement, the two or more cutter bar arms may share a common drive, which controls the degree of asynchronicity between the blades in an ongoing manner. In contrast, “independently” means that each cutter bar arm would have its own dedicated drive, and may move in and out of phase relative to the other arm or arms as they encounter differing levels of resistance as they move through the ground.

In an implementation, the cutter bar arm and mast assembly may offset to the side in relation to the centreline of the tractor's wheelbase. This offset would allow the cutter bar arm to be placed closer to root system's centre or root ball than would be possible with a centre-mounted assembly.

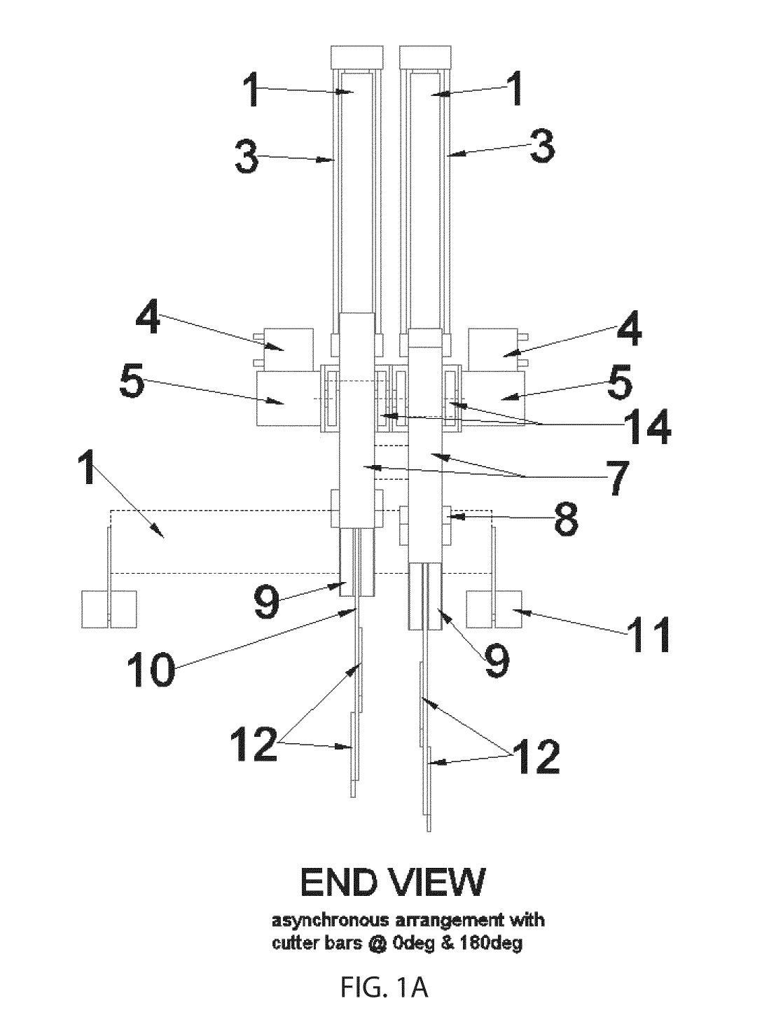

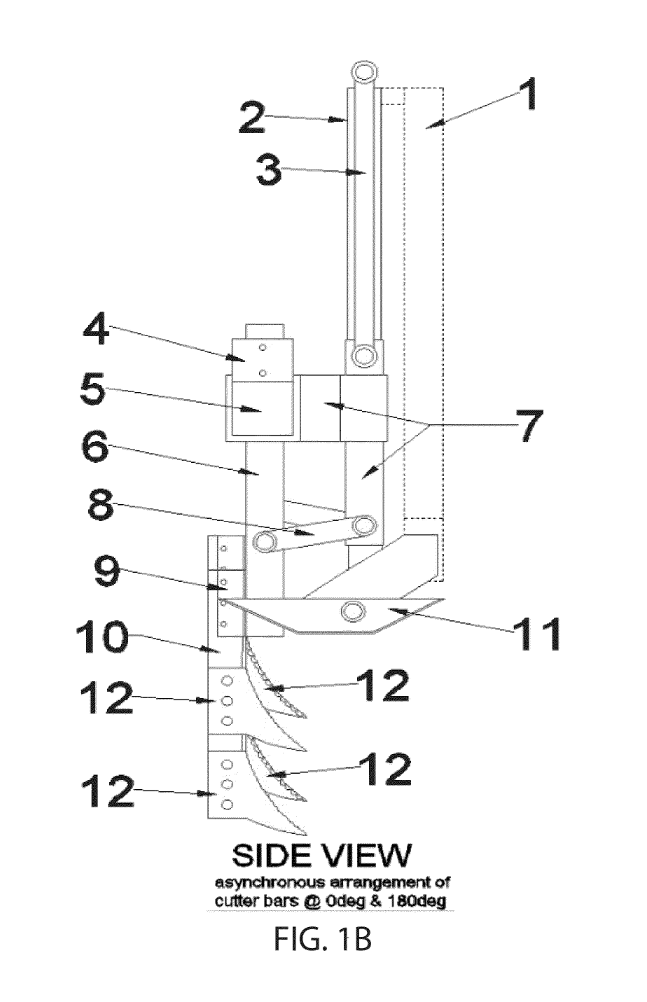

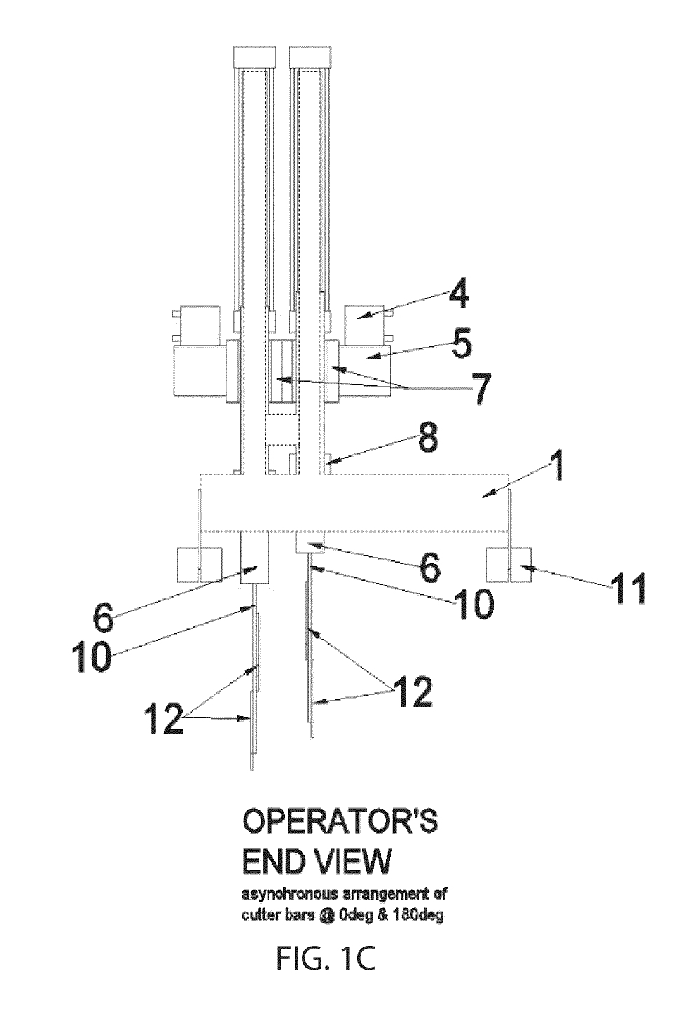

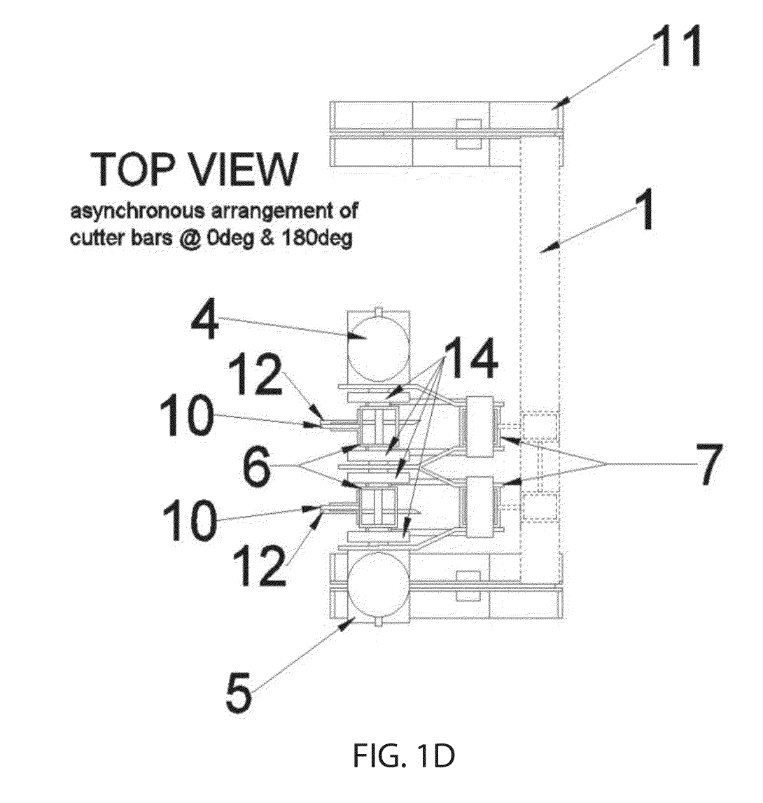

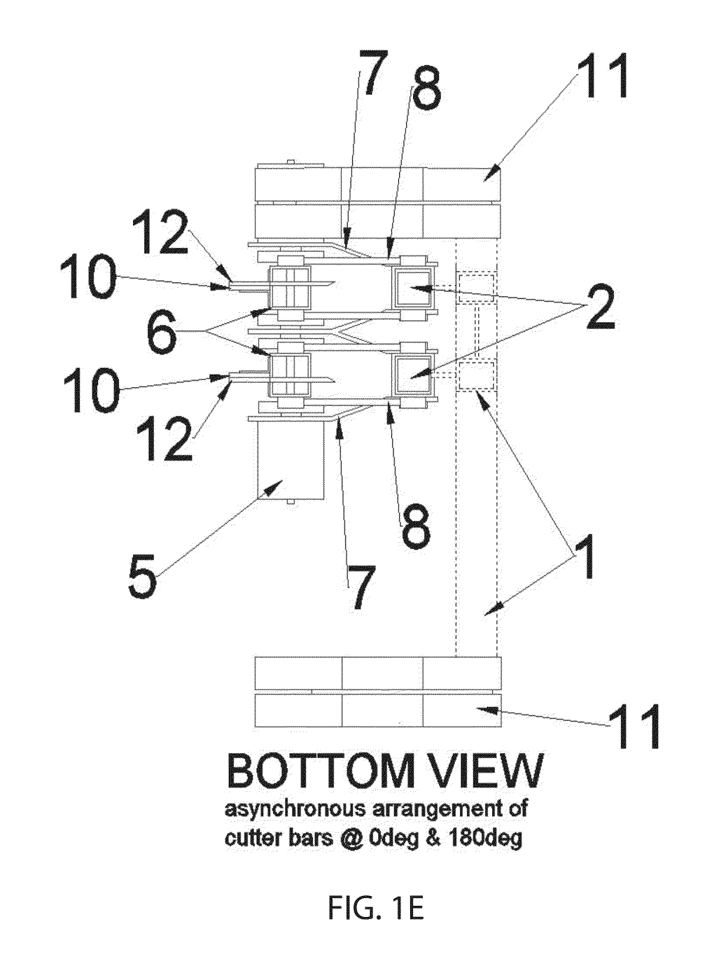

FIGS. 1A-1E are, respectively, end, side, operator's end, top, and bottom views of a cutting device having an asynchronous cutting arm in which two blades orbit 180 degrees out of sync.

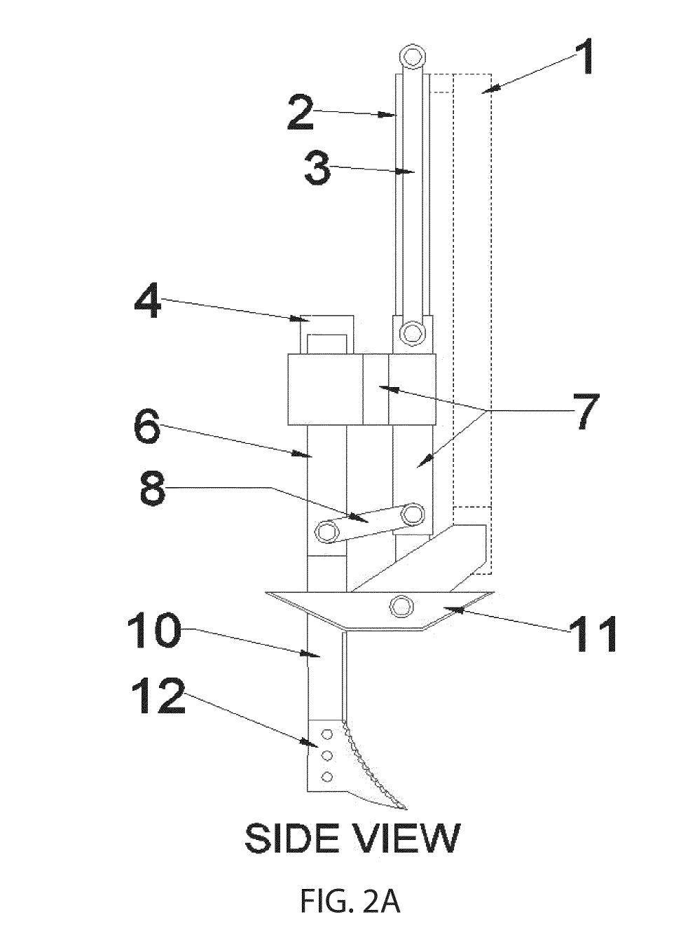

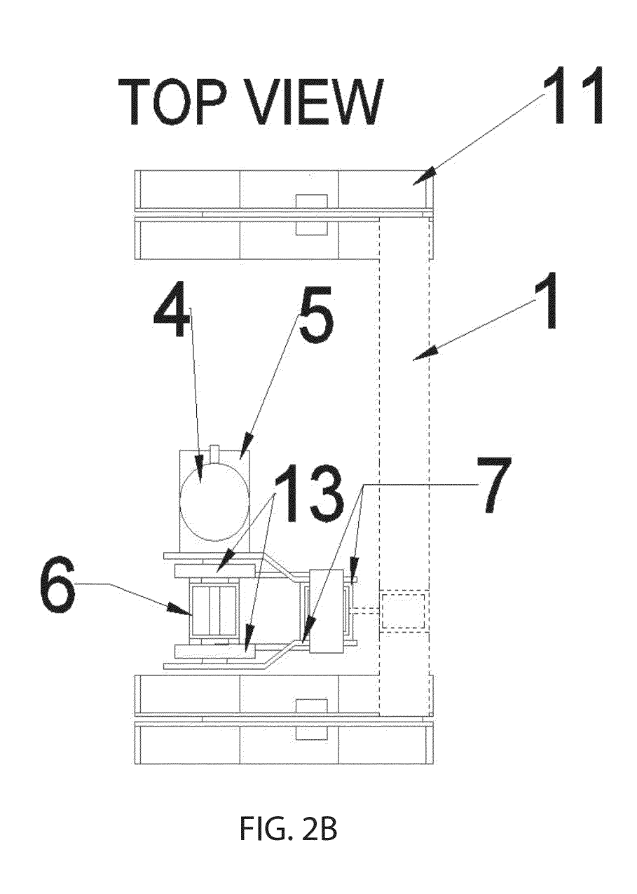

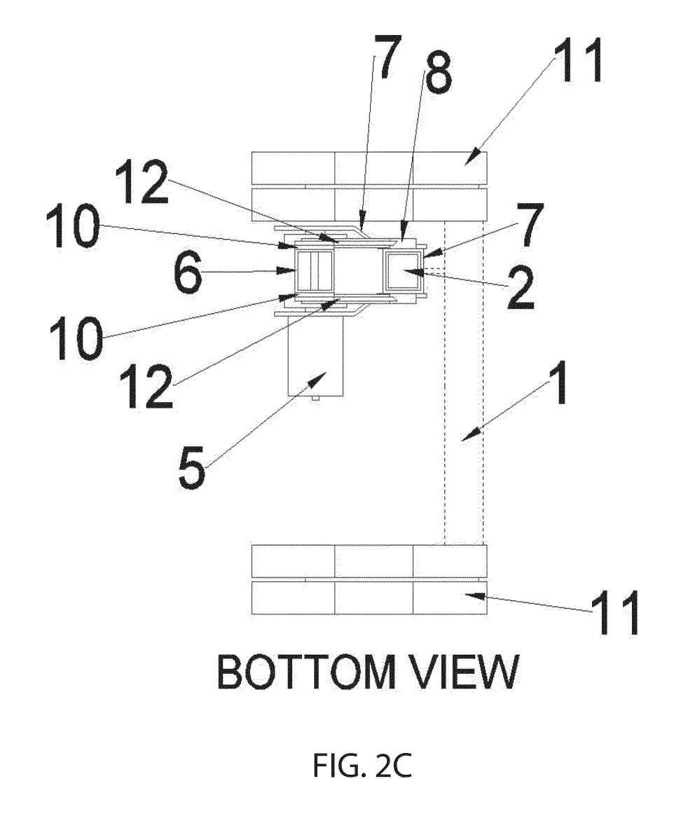

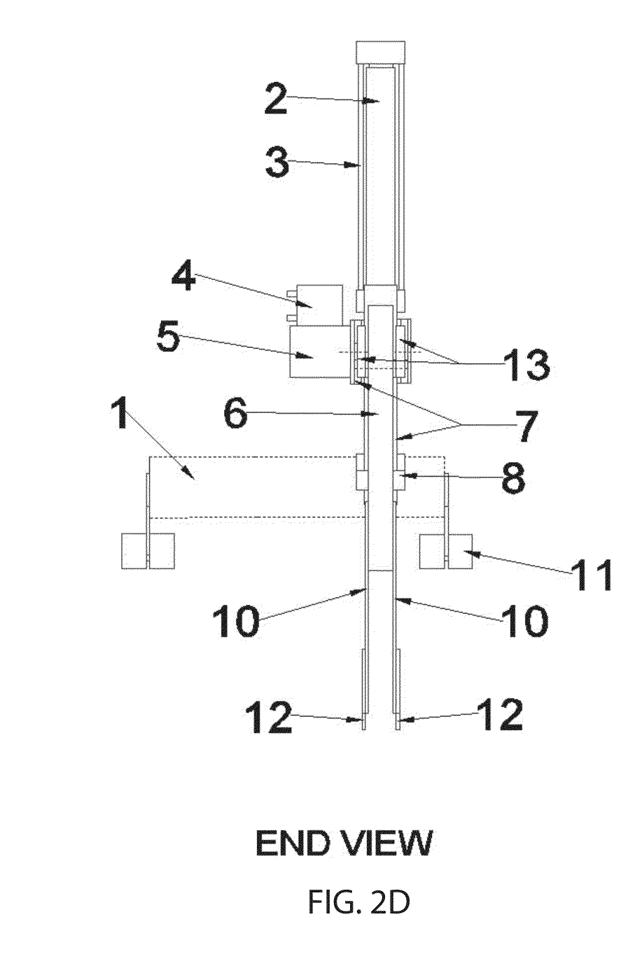

FIGS. 2A-2D are, respectively, side, top, bottom, and end views of a cutting device having a single cutting arm.

The elements indicated by the reference numerals 1-14 are described in the following table:

| Ref# | Description |
|---|---|
| 1 | Support frame (shown as dotted). Specific design |
| | determined by the type of vehicle to which the blade |
| | assembly is to be attached. The vehicle-specific |
| | interfacing structure by which the device proper (items |
| | 1-10 & 12-14) is connected to the drive vehicle. The |
| | support frame directly secures the carriage mast (item |
| | 2) and the sliding shoes or skids (the latter which |
| | rest on ground providing counter-force to the blade/s |
| | cutting action). The support frame may also be used to |
| | mount a PTO-driven hydraulic pump and reservoir to |
| | power the raise/lower hydraulics (items 2 & 3) and the |
| | blade/s drive (item 13). |
| 2 | Carriage mast. Provides the means by which cutter |
| | bar/blade/s assembly is raised/lowered into the ground |
| | and which houses the hydraulic ram/s that power this |
| | movement. The carriage mast is directly connected to the |
| | support frame and provides the path by which the cutter |
| | bar carriage (item 7) moves to enable the cutter bar/s |
| | (item 10) and the blades thereon (item 12) to enter/leave |
| | the ground. |
| 3 | Hydraulic link arms. These transfer raising and lowering |
| | power to the blade/s bar carriage. Fixed at the lower |
| | end to the blade/s bar carriage (item 2) and at the upper |
| | end to hydraulic ram housed within the carriage mast; |
| | this transfers the power by which the blade/s bar |
| | carriage (item 7) that moves to enable the blade/s bar/s |
| | (item 10) and the blades thereon (item 12) to enter/leave |
| | the ground. |
| 4 | Hydraulic motor. This powers the cutter bar/blade |
| | assembly. This is mounted on the cutter bar/blade/s |
| | assembly drive; the rotating motion of the drive directly |
| | imparts the vertical component (as relative the ground) |
| | of the blades' (item 12) ellipsoid motion and, in concert |
| | with the motion control linkages (item 8), imparts the |
| | horizontal component (as relative to the ground i.e. |
| | 90degrees from the vertical) of the blades' ellipsoid |
| | motion producing the cutting action to the blade/s. |
| 5 | Gearbox. This is not required in all iterations of the |
| | invention. Where applicable, the gearbox is typically |
| | mounted on the cutter bar/blade/s drive and modifies |
| | drive direction, speed and power as determined by the |
| | operator. |
| 6 | Cutter bar arm [secured at the top by the rotating drive |
| | (13) and midway by the motion control linkages (8). The |
| | blade/s (12) are mounted on the lower end of the cutter |
| | bar/s (item 10). The cutter bar arm is the means by which |
| | ellipsoid motion is delivered to the blades. The |
| | ellipsoid motion is more fully articulated in diagram 2A |
| | which shows the changes in the ellipsoid motion which is |
| | achievable by varying the ratio of the distance traveled |
| | by the vertical and horizontal connection bars which |
| | provide the ellipsoid motion to the blade/s. |
| 7 | Cutter bar carriage - supports the cutter bar's rotary |
| | drive [item 13] and anchors the carriage mast end of |
| | motion control linkage arm/s shown in item 7. |
| 8 | Motion control linkages. These provide the blade's |
| | horizontal cutting motion component via link between |
| | carriage & cutter bar arm [Mounted below the rotary drive |
| | (item 13) with one end fixed to the carriage mast (item |
| | 2) via a flexible linkage; and the other end fixed to |
| | the cutter bar arm/s (item 6) via flexible linkage] |
| 9 | Blade/s bar mount being the means of securing the blade/s |
| | mounting bar/s (item 10) to the cutter bar arm/s (item |
| | 6). |
| 10 | Blade/s bar. Mounted at the bottom end of the cutter bar |
| | arm/s (item 9) by means of the blade/s bar mounts (item |
| | 9) and used to support the blade/s (item 12). |
| 11 | Sliding shoes (skids) are mounted on the support frame |
| | (item 1). During operation they rest on ground providing |
| | counter-force to the upward portion of the assembly's |
| | cutting action to reduce yaw and pitch and to reduce |
| | stress upon the vehicle and the unit mounting points and |
| | hydraulic linkages. |
| 12 | Unit's blade/s. The blades are shaped to maximize the |
| | period the blade's cutting edge is in contact with the |
| | material being cut. The blades cut on the upwards/forward |
| | path of the ellipsoid path, then are withdrawn on the |
| | downwards/backwards sector and re-engage on the upwards/ |
| | forward path so long as the unit is in operation. |
| 13 | Drive. This rotates to provide the blade's vertical |
| | cutting motion component via movement of the cutter bar |
| | arm. It is mounted on the cutter bar carriage (item 7); |
| | the motion of the drive directly imparts the vertical |
| | component of the blades' (item 12) ellipsoid motion and, |
| | in concert with the motion control linkages (item 8), |
| | imparts the horizontal component of the blades' ellipsoid |
| | motion. Collectively, the cutter bar arm (6), the motion |
| | control linkages (8) and the hydraulically powered rotary |
| | drive (13) form an orbit-causing means (or mechanism) |
| | for causing the moveable cutting blade (12) to orbit in |
| | an ellipsoidal pattern. |
| 14 | Asynchronous or independent (unlinked) blade/s drive. |

As shown in FIGS. 1A-1E, the support frame (numbered 1) is attached to the vehicle providing the propulsion and power supply for the device. When deployed, the unit is affixed to a means of propulsion such as a tractor or comparable vehicle which has a hydraulic power output capability or PTO. The hydraulic power from the vehicle or the vehicle's PTO, provides motive power to the blade's drive assembly as noted in item 4 in the above table or, where fitted, the gearbox noted in item 5 of the above table. In one iteration of the device, there is fitted a sensor which monitors the hydraulic pressure so as to cut power to one or both blade/s should one or both encounter material which is too resilient/hard for the blade/s to cut through. A warning indicator alerts the operator who then may take appropriate action such as re-attempting to cut through the obstruction or lift the cutter bar out of the ground, proceed a certain distance thereupon re-engaging the until which then drives the cutter bar/blade/s into the ground to resume cutting.

The cutting device described herein may provide several potential advantages. For example, the elliptical motion of the cutting head is such that the motion has the long axis of the ellipse in a horizontal plane rather than vertical; as a result, the cutting blade cuts on the advance stage, then backs off and clears the blade before coming forward (effectively from underneath the object being cut) to cut again.

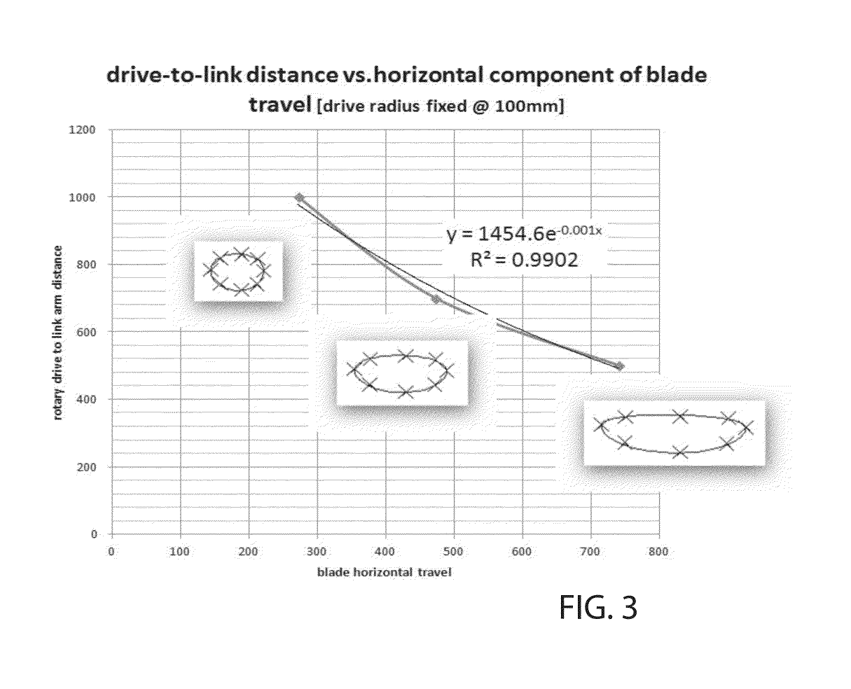

The expression “vertical” refers to the motion of the blade/s relative to the surface of the ground in which they are being deployed. This is shown as the vertical axis in FIG. 3.

The expression “horizontal” refers to the motion 90 degrees to the vertical motion and is shown as the horizontal axis in FIG. 3.

Other embodiments are within the scope of the following claims.

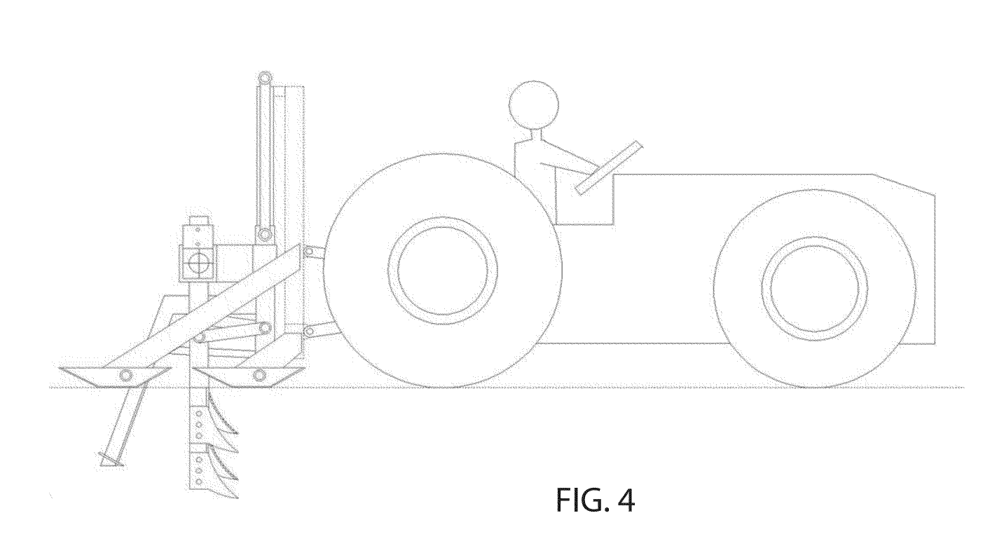

In one iteration of the device, the mounting as shown in 1 of the table above, is fixed to the vehicle. This is illustrated in FIG. 4.

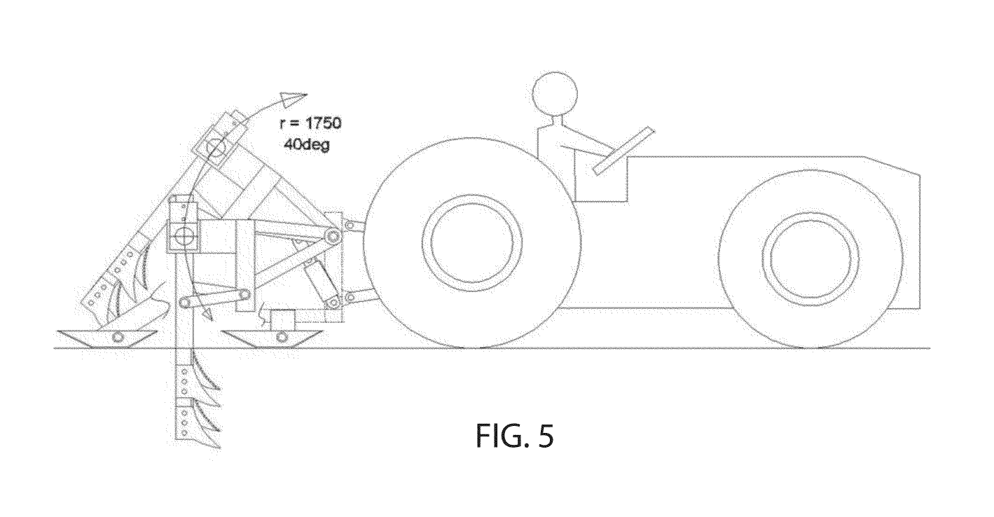

In another iteration of the device, the mounting is capable of being swing back and up, so as to disengage the blade/s by lifting them out of the ground in a swinging or an arc-like motion. This is illustrated in FIG. 5.

In another embodiment, the device may be combined with a cable laying device to complement the latter device's function of simultaneously digging a trench of varying depth and laying a conduit or pipe directly behind the trenching element of these devices. As currently deployed, the trenching device is a hook shaped fixed blade pulled through the ground behind a tractor or similar power supply but these devices are unable to operate where there are underground root systems or existing subterranean cables which entangle and impede a simple fixed blade whereas such an impediment is able to be cut in situ by the subject device which uses a powered blade array.

What is claimed is:

1. A cutting device comprising:
a. a support frame (1);
b. a skid (11) connected to the support frame (1) and configured to contact ground when the cutting device is in use;
c. at least one moveable cutting blade (12) extending below the skid (11); and
d. orbit-causing means (6, 8, and 13) for causing the moveable cutting blade (12) to orbit in an ellipsoidal pattern.

2. The cutting device of claim 1 further comprising two moveable cutting blades (12) configured to orbit 180 degrees out of phase with each other or independently.

3. The cutting device of claim 2 wherein each moveable cutting blade (12) is separately configured to compensate for variations in elliptical-oscillation movement.

4. The cutting device of claim 1 further comprising a plurality of moveable cutting blades (12), wherein a quantity of cutting blades is proportional to a depth at which the cutting device is to operate.

5. The cutting device of claim 1 wherein the at least one moveable cutting blade (12) comprises a curved member with teeth.

6. The cutting device of claim 1 further comprising a vertical member (6) operatively coupled via a drive (13) to the support frame (1) such that the vertical member (6) can be oscillated vertically, and wherein the orbit-causing means (6, 8, and 13) converts vertical oscillation of the vertical member (6) to ellipsoidal motion.

7. A method of cutting sub-surface entities, the method comprising:
a. extending a first cutting blade into a sub-surface location adjacent to, and in contact with, an object to be cut; and
b. converting vertical oscillation input into elliptical motion to cause the first cutting blade to move in an elliptical pattern relative to a second cutting blade.

8. The method of claim 7 further comprising using a common drive to control a phase difference between the first and second cutting blades to maintain the phase difference at a predetermined degree.

9. The method of claim 7 further comprising using, for each of the first and second cutting blades, a dedicated drive to control the elliptical pattern of the respective cutting blades such that the first and second cutting blades move independently of each other.
